(19) United States
(12) Patent Application Publication
(10) Pub. No.: US 2004/0250086 A1
(43) Pub. Date: Dec. 9, 2004

(54) Method and system for protecting against software misuse and malicious code

(75) Inventor: Jon Anthony Maucher, Palm Bay, FL (US)

Correspondence Address: CHRISTOPHER F. REGAN, ESQUIRE, ALLEN, DYER, DOPPELT, MILBRATH & GILCHRIST, P.A., P.O. Box 3791, Orlando, FL, 32802-3791, US

(73) Assignee: Harris Corporation, Melbourne, FL (US)

(21) Appl. No.: 10/445,154

(22) Filed: May 23, 2003

(51) Int. Cl. H04L 9/32

(52) U.S. Cl. 713/187; 713/176

(57) ABSTRACT

A method of computer processing is for protecting against software misuse and malicious code. The method includes generating a formal specification defining permitted actions for an application, and linking the formal specification with the application so that the formal specification travels with the application. A signature is attached to the application to create a trusted application. The method further includes reading the trusted application to determine a requested action, and checking the signature to determine if the trusted application is authentic. The formal specification is checked and performance of the requested action is permitted if the requested action is among the permitted actions defined by the formal specification, and if the signature is authentic.

### FIELD OF THE INVENTION

The present invention relates to the field of computers, and more particularly, to the protection of a computer system from software misuse and from the execution of malicious code.

### BACKGROUND OF THE INVENTION

Software misuse and the execution of malicious code can cause undesirable effects on a computer system. The misuse of software applications may be intentional, or it may be unknown to the user. Malicious code is code that is added, changed or removed from a computer system to intentionally cause harm by instructing an application to perform an unintended function.

One approach to protecting a computer system is to set access controls at the system level. Access controls provide protection on the loss of sensitive data by denying access to the sensitive data based upon the user of the system. However, the loss of sensitive data can still occur by exploiting the application running under a privileged user.

Code signing or signature-based protection is another approach for protecting a computer system. Signature-based protection requires software developers to obtain certificates of authenticity for their application to run. Protecting a computer system from malicious code may also be done at the application level. This approach is also known as sandbox-based protection because the protection wraps or hooks certain code to prevent malicious operations. An example of protecting a computer system at the application level from malicious code is disclosed in U.S. Pat. No. 6,167,520 to Touboul. More commonly known as Finjan software, the '520 patent discloses the use of probes at the application level for intercepting malicious code before it gets to the operating system.

Intrusion prevention software, such as STAT Neutralizer™, may also be implemented for protecting a computer system. STAT Neutralizer™, developed by the current assignee of the present invention, protects the computer system by hooking the kernel calls that control file and registry key creation, reading, writing and deletion.

A disadvantage of the sandbox-based protection and the intrusion prevention software is that determination of what is permitted or denied by the computer system is usually done by someone that is not as intimately familiar with the application as the application designer would be. This can result in “breaking” the application. That is, performance of a requested action is denied even though the action would normally be permitted.

### SUMMARY OF THE INVENTION

In view of the foregoing background, it is therefore an object of the present invention to protect a computer system from software misuse and from malicious code while reducing the possibility of denying performance of a requested action that would normally be permitted.

This and other objects, features, and advantages in accordance with the present invention are provided by a method of computer processing comprising generating a formal specification defining permitted actions for an application, and linking the formal specification with the application so that the formal specification travels with the application. A signature may be attached to the application to create a trusted application.

The method may further include reading the trusted application to determine a requested action, and checking the signature to determine if the trusted application is authentic. The formal specification may be checked, and performance of the requested action may be permitted if the requested action is among the permitted actions defined by the formal specification, and if the signature is authentic.

The trusted application advantageously provides a very high degree of confidence that an unauthorized action will not be permitted, and at the same time, provides a very high degree of confidence that an authorized action will be permitted. The present invention allows the application designer to precisely specify the actions the application should perform under normal circumstances.

If the application is exploited, any actions or activities that the application designer did not intend to be performed will be denied. An additional benefit is in the use of mobile applications such as agent software. By embedding the application's formal specification in the application itself, agents can be distributed on a computer system with a high degree of assurance that they will operate correctly.

The method may further comprise generating a system policy also defining permitted actions, and checking the system policy to determine if the requested action is among the permitted actions defined by the system policy. Performance of the requested action is permitted if the requested action is among the permitted actions defined by the system policy.

The formal specification and the system policy deny actions for at least one of operating system functions, file functions, registry functions, library functions, communication functions and network functions. The application may operate in a Windows based environment, a Solaris based environment or a Linux based environment. In addition, the application may include at least one of a word processing application, a spread sheet application, an e-mail application, and a web browser application.

Another aspect of the present invention is directed to a computer system comprising a processor for executing an application, and a memory connected to the processor and having stored therein the application and a formal specification defining permitted actions for the application. The formal specification may be linked with the application so that the formal specification travels with the application, and the application has a signature attached thereto to create a trusted application.

The processor may read the trusted application to determine a requested action, and check the signature to determine if the trusted application is authentic, and check the formal specification. The processor permits the requested action if the requested action is among the permitted actions defined by the formal specification, and if the signature is authentic.

### BRIEF DESCRIPTION OF THE DRAWINGS

FIG. 1 is a block diagram of a computer system including a trusted application in accordance with the present invention.

FIG. 2 is a flowchart illustrating a method of computer processing in accordance with the present invention.

FIG. 3 is a block diagram illustrating the compilation process of the trusted application in accordance with the present invention.

FIG. 4 is a block diagram illustrating the execution environment of the trusted application in accordance with the present invention.

FIG. 5 is a block diagram illustrating the sequence of events for initializing execution of the trusted application in accordance with the present invention.

FIG. 6 is a block diagram illustrating the sequence of events for executing a requested action by the trusted application in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention is effective at protecting a computer system from software misuse and from malicious code when executing an application on the computer system, while reducing the possibility of denying performance of a requested action that would normally be permitted by the application. The application may be a word processing application, a spread sheet application, an e-mail application, and a web browser application, for example.

The application designer or someone intimately familiar with the application may specify the precise actions the application should perform under normal circumstances. When the computer system is executing the application and it is determined that the application is being exploited, any actions that the application designer did not intend to be performed are denied. This is accomplished by embedding the behavior that the application is designed to perform in the application executable image. The application advantageously provides a high level of assurance that it will perform as designed. In other words, the application is a trusted application.

Three components may be used for implementing a trusted application in a computer system. The first component is a formal specification. The formal specification defines the behavior or actions that the application was designed to perform The specification is preferably defined at the same time the application is designed.

The second component is the compilation and linking of the formal specification into the application itself. This allows the specification to travel with the application regardless of the method of distribution within the computer system. The third component is the execution environment. The execution environment reads the formal specification from the application, and ensures that the application does not perform an action that is outside of the specification.

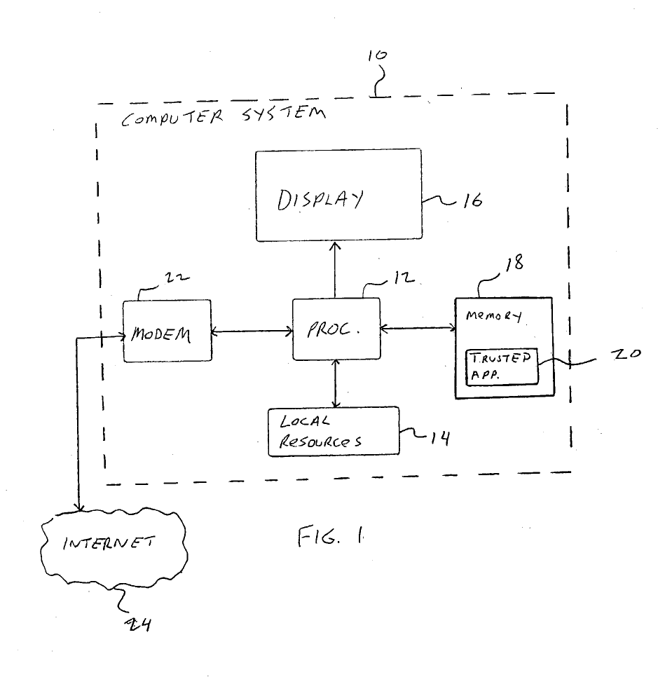

Referring now to FIG. 1, the computer system 10 includes a processor 12 having an operating system associated therewith, and at least one local resource 14 controlled by the operating system. The at least one local resource 14 may be a hard drive, a floppy drive, a CD drive, or a zip drive, for example, as will be appreciated by those skilled in the art.

A display 16 is connected to the processor 12, and a memory 18 is connected to the processor for storing therein the trusted application 20, i.e., the formal specification linked with the application. The memory 18 may be separate from the processor 12 as illustrated in FIG. 1, or may be embedded therein. The operating system for the illustrated computer system 10 may be Windows based. However, the present invention is not limited to the Windows operating system, and may be based on a Solaris or Linux operating system, for example, as will be readily appreciated by those skilled in the art.

A modem 22 and a corresponding communications driver interfaces the computer system 10 to the Internet 24. The computer system 10 may also be part of a local area network (LAN) connected to the Internet 24. In that case, the computer system 10 may be connected to the Internet via a server, and includes an Ethernet or similar hardware card instead of a modem 22. The host computer 10 may thus receive malicious code via network-enabled components (e.g., the modem 22), or through external storage devices (e.g., a floppy drive, a CD drive, or a zip drive), including mapped hard drives as may be the case for a computer system connected to the LAN.

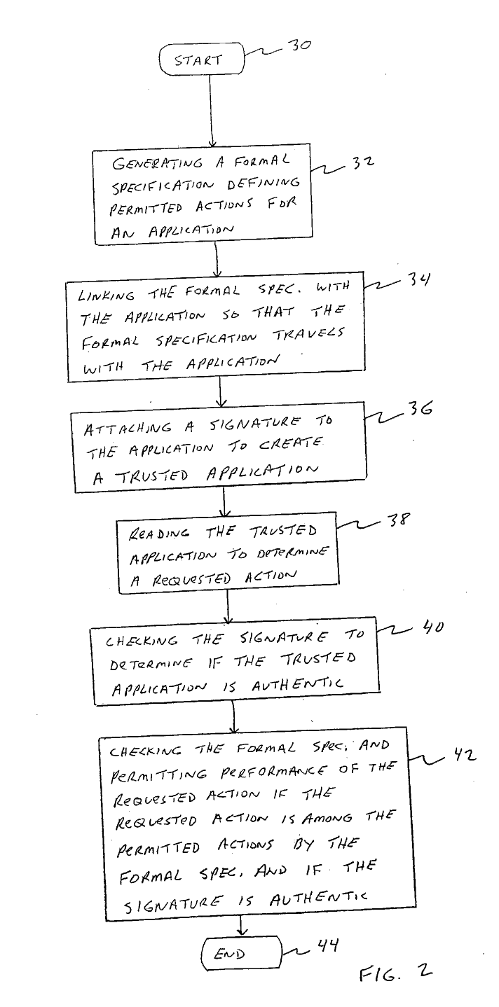

A flowchart illustrating a method of computer processing in accordance with the present invention is illustrated in FIG. 2. From the start (Block 30), a formal specification defining permitted actions for an application is generated at Block 32. The formal specification defines the behavior or actions that are expected from the application. Preferably, the system designer generates the formal specification before the application is released. The formal specification may deny, for example, any one of the following actions: operating system functions, file functions, registry functions, library functions, communication functions and network functions. Oftentimes software misuse or malicious code causes an application to perform an action that causes an undesirable effect on the computer system.

The formal specification may also be generated after the application has been released, preferably by someone who is intimately familiar with the application. The formal specification defines which resources the application is expected to use and how the application expects to use them. For example, if an application is designed to read and write files with a “.srt” extension, the formal specification would state that file reading or writing of any file matching “.srt” is permitted. If the application attempts to read or write to a file that does not match the specification, the execution environment denies performance of that action.

After the formal specification has been generated, it is necessary to embed the specification into the application. The specification is compiled into a form understandable by a security monitor, and is embedded into the application. This is accomplished by a linker, which embeds the specification in the final executable image at Block 34, as readily understood by those skilled in the art. The formal specification is now linked with the application so that the formal specification travels with the application.

The method further includes at Block 36 attaching a signature to the application to create a trusted application 20. The application is cryptographically signed, as readily understood by those skilled in the art. The trusted application 20 is read to determine a requested action at Block 38. The signature is checked in the execution environment at Block 40 to ensure that the executable image (especially the specification) has not been modified. That is, the signature is checked to determine if the trusted application 20 is authentic.

The formal specification is checked at Block 42 and performance of the requested action is permitted if the requested action is among the permitted actions by the formal specification, and if the signature is authentic. The method ends at Block 44.

The requested action is denied if the trusted application 20 is not authentic, or if the quested action is not among the permitted actions defined by the formal specification. The method may also include generating a system policy also defining permitted actions. The system policy is also checked to determine if the requested action is among the permitted actions defined by the system policy. Performance of the requested action is permitted if the requested action is among the permitted actions defined by the system policy. The system policy may be checked after the signature has been checked, and before the formal specification is checked. The system policy may take precedence over the formal specification, and consequently, is checked before the formal specification is checked. Alternately, the system policy may be checked after the formal specification has been checked.

If the requested action is not among the permitted actions defined by the system policy, then the requested action is denied. Since the system policy may have priority over the formal specification, it typically limits the permitted actions defined by the formal specification. For example, if the requested action is to write data to a floppy disk, the formal specification may permit the requested action, yet the system policy denies the requested action. Consequently, the application would be denied from writing data to the floppy disk.

Once the formal specification has been checked, and it is determined to be authentic, at least a portion of the formal specification is stored in a memory for a next requested action. This feature of the present invention allows the requested actions to be more quickly compared against the formal specification.

Referring now to FIG. 3, the compilation process of the trusted application 20 is further described. The behavior of the formal specification 50 is applied as input to a specification compiler 52. The specification complier 52 generates a compiled formal specification 54.

A linker 56 links the compiled formal specification 54 with the compiled object files from the application 58 to create executable files, i.e., an application embedded with the formal specification module 60. Since the application is embedded with the formal specification, the application travels with the formal specification. A signature is then attached to the application using a signature application device 62 to create the trusted application 20. The signature may be based upon the RSA industry standard, for example, as readily understood by those skilled in the art.

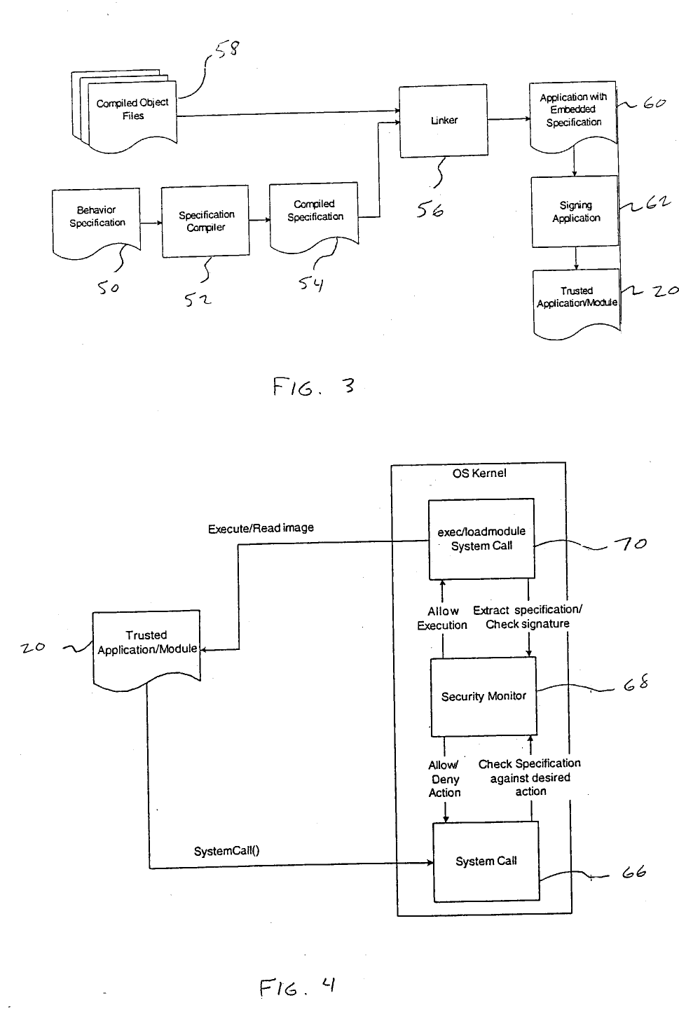

Once the compilation is completed, the formal specification is to be enforced whenever the application is executed on the computer system 10. The sequence of events for initializing execution of the trusted application 20 is described in FIG. 4. Starting with the trusted application 20, a requested action, i.e., a system call, is made to the system call module 66. If an execution is about to take place, the system call module 66 notifies the security monitor 68.

The security monitor 68 then notifies the executable/load system call module 70 so that the formal specification and the signature may be extracted from the trusted application 20. This information is then passed to the security monitor 68.

The security monitor 68 checks the signature to determine if the trusted application 20 is authentic, and also checks the formal specification to determine if the requested action is permitted. If the requested action is among the permitted actions defined by the formal specification 54 and if the signature is authentic, the security monitor 68 notifies the system call module 66 that the requested action is permitted, and also notifies the executable/load system call module 70 to execute the requested action.

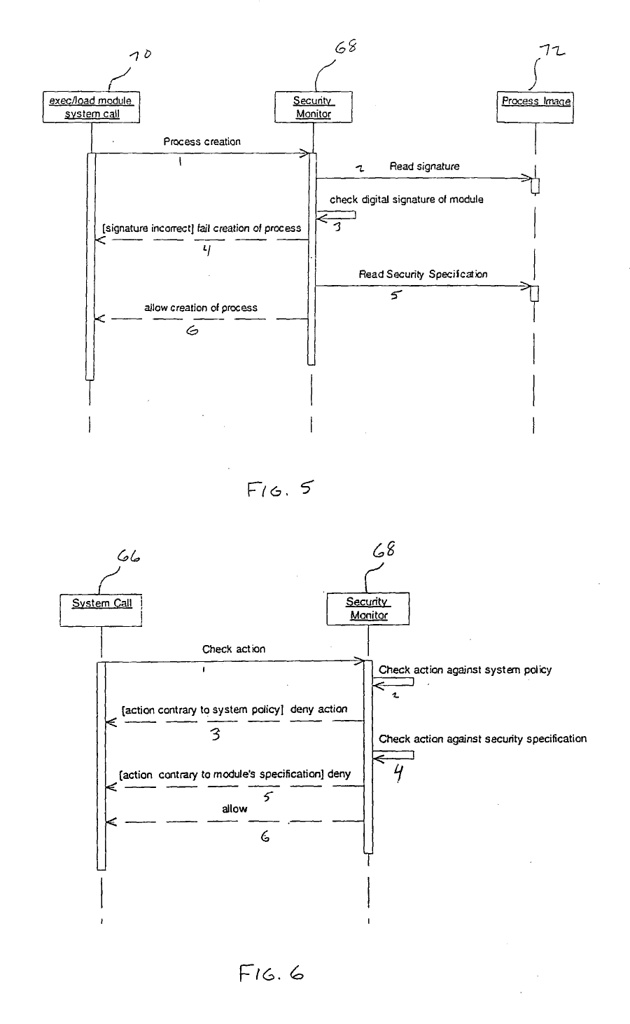

The sequence of events for initializing execution of the trusted application 20 is further described in FIG. 5. The executable/load system call module 70 notifies the security monitor 68 along path 1 that the application is to be executed. The security monitor then reads the signature from the application (process image) 72 along path 2. The security monitor 68 checks the authenticity of the signature along path 3.

If the signature is incorrect, the security monitor notifies the executable/load system call module 70 along path 4 that the application can not be executed. If the signature is correct, the security monitor 68 reads the formal specification from the application along path 5. At this point, the formal specification may be stored in a memory for checking against the requested actions, and the executable/load system call module 70 allows the application to be executed.

The sequence of events for execution of a requested action by the trusted application 20 (after the events in FIG. 5 have been performed) in accordance with the present invention is further described in FIG. 6. The system call module 66 notifies the security monitor 68 along path 1 that an action is to be performed. The security monitor 68 checks the requested action against the system policy along path 2, and if the requested action is denied by the system policy, the system call module 66 is notified along path 3 that the requested action has been denied.

If the requested action is allowed by the system policy, then the security monitor 68 checks the requested action against the formal specification along path 4. Depending on the results of this check, the system call module 66 is notified along path 5 that the requested action has been denied, or that the requested action is allowed along path 6.

Another aspect of the present invention is directed to a machine readable medium for a computer system 10 comprising a processor 12 for executing an application, and a memory 18 connected to the processor and having stored therein the application and a formal specification defining permitted actions for the application. The formal specification is linked with the application so that the formal specification travels with the application. As discussed above, the application has a signature attached thereto to create a trusted application 20.

The machine readable medium has machine readable instructions stored thereon for causing the computer system 10 to perform the following: reading the trusted application 20 to determine a requested action; checking the signature to determine if the trusted application is authentic; and checking the formal specification and permitting performance of the requested action if the requested action is among the permitted actions defined by the formal specification, and if the signature is authentic.

In summary, the use of a digitally signed formal specification precisely defines the permitted actions of an application. This concept builds on sand-based protection, code signing or signature-based protection, and on intrusion prevention protection as discussed above. This is a system approach for protecting a computer system from software misuse and from malicious code.

When the application is executed on the computer system 10, several actions are to take place. First, the security monitor 68 is notified that an execution is about to take place by the application execution system call module 70 of the operating system. The security monitor 68 then extracts the digital signature and specification from the application. If the digital signature is correct and trusted, the security monitor 68 stores the formal specification in a memory for later reference. If the digital signature is incorrect (or optionally not present), the security monitor 68 informs the execute system call 70 to deny the execution of the application. After the formal specification is loaded into the memory, any system call (i.e., any requested action) to be performed by the application is checked against the formal specification.

Whenever a system call by the application occurs, the system call module 66 queries the security monitor 68 to see if the requested action should be allowed. The security monitor 68 checks any system policy that may be present and then checks that the requested action is within the bounds of actions defined by the formal specification. If either of the checks are against the system policy or the formal specification, the system call module 66 is informed to deny the action. If both checks are within the policy and specification, the system call module 66 is informed to allow the action to occur.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method of computer processing comprising:
generating a formal specification defining permitted actions for an application;
linking the formal specification with the application so that the formal specification travels with the application;
attaching a signature to the application to create a trusted application;
reading the trusted application to determine a requested action;
checking the signature to determine if the trusted application is authentic; and
checking the formal specification and permitting performance of the requested action if the requested action is among the permitted actions defined by the formal specification, and if the signature is authentic.

2. A method according to claim 1 further comprising denying the requested action if the trusted application is not authentic.

3. A method according to claim 1 further comprising denying the requested action if the requested action is not among the permitted actions defined by the formal specification.

4. A method according to claim 1 further comprising:
generating a system policy also defining permitted actions for the application; and
checking the system policy to determine if the requested action is among the permitted actions defined by the system policy, and permitting performance of the requested action if the requested action is among the permitted actions defined by the system policy.

5. A method according to claim 4 further comprising denying the requested action if the requested action is not among the permitted actions defined by the system policy.

6. A method according to claim 4 wherein the system policy denies actions for at least one of operating system functions, file functions, registry functions, library functions, communication functions and network functions.

7. A method according to claim 1 wherein if the trusted application is authentic, further comprising storing at least a portion of the formal specification in a memory for a next requested action.

8. A method according to claim 1 wherein the formal specification denies actions for at least one of operating system functions, file functions, registry functions, library functions, communication functions and network functions.

9. A method according to claim 1 wherein the application operates in at least one of a Windows based environment, a Solaris based environment and a Linux based environment.

10. A method according to claim 1 wherein the application comprises at least one of a word processing application, a spread sheet application, an e-mail application, and a web browser application.

11. A method of computer processing comprising:
generating a formal specification defining permitted actions for an application, and generating a system policy also defining permitted actions for the application;
linking the formal specification with the application so that the formal specification travels with the application;
attaching a signature to the application to create a trusted application;
reading the trusted application to determine a requested action;
checking the signature to determine if the trusted application is authentic;
checking the system policy to determine if the requested action is among the permitted actions defined by the system policy; and
checking the formal specification and permitting performance of the requested action if the requested action is among the permitted actions defined by the formal specification, and if the signature is authentic and if the requested action is among the permitted actions defined by the system policy.

12. A method according to claim 11 further comprising denying the requested action if the trusted application is not authentic.

13. A method according to claim 11 further comprising denying the requested action if the requested action is not among the permitted actions defined by the formal specification, or if the requested action is not among the permitted actions defined by the system policy.

14. A method according to claim 11 wherein the formal specification and the system policy denies actions for at least one of operating system functions, file functions, registry functions, library functions, communication functions and network functions.

15. A method according to claim 11 wherein if the trusted application is authentic, further comprising storing at least a portion of the formal specification in a memory for a next requested action.

16. A method according to claim 11 wherein the application comprises at least one of a word processing application, a spread sheet application, an e-mail application, and a web browser application.

17. A machine readable medium for a computer system comprising a processor for executing an application; and a memory connected to the processor and having stored therein the application and a formal specification defining permitted actions for the application, the formal specification being linked with the application so that the formal specification travels with the application, and the application having a signature attached thereto to create a trusted application; the machine readable medium having machine readable instructions stored thereon for causing the computer system to perform the following:
reading the trusted application to determine a requested action;
checking the signature to determine if the trusted application is authentic; and
checking the formal specification and permitting performance of the requested action if the requested action is among the permitted actions defined by the formal specification, and if the signature is authentic.

18. A machine readable medium according to claim 17 further comprising denying the requested action if the trusted application is not authentic.

19. A machine readable medium according to claim 17 further comprising denying the requested action if the requested action is not among the permitted actions defined by the formal specification.

20. A machine readable medium according to claim 17 further comprising checking a system policy to determine if the requested action is among permitted actions also defined by the system policy, and permitting performance of the requested action if the requested action is among the permitted actions defined by the system policy.

21. A machine readable medium according to claim 20 further comprising denying the requested action if the requested action is not among the permitted actions defined by the system policy.

22. A machine readable medium according to claim 20 wherein the system policy denies actions for at least one of operating system functions, file functions, registry functions, library functions, communication functions and network functions.

23. A machine readable medium according to claim 17 wherein if the trusted application is authentic, further comprising storing at least a portion of the formal specification in a memory for a next requested action.

24. A machine readable medium according to claim 17 wherein the formal specification denies actions for at least one of operating system functions, file functions, registry functions, library functions, communication functions and network functions.

25. A machine readable medium according to claim 17 wherein the application comprises at least one of a word processing application, a spread sheet application, an e-mail application, and a web browser application.

26. A computer system comprising:
a processor for executing an application; and
a memory connected to said processor and having stored therein the application and a formal specification defining permitted actions for the application, the formal specification being linked with the application so that the formal specification travels with the application, and the application having a signature attached thereto to create a trusted application;
said processor reading the trusted application to determine a requested action, checking the signature to determine if the trusted application is authentic, and checking the formal specification and permitting performance of the requested action if the requested action is among the permitted actions defined by the formal specification, and if the signature is authentic.

27. A computer system according to claim 26 wherein said processor denies the requested action if the trusted application is not authentic.

28. A computer system according to claim 26 wherein said processor denies the requested action if the requested action is not among the permitted actions defined by the formal specification.

29. A computer system according to claim 26 wherein said processor further checks a system policy to determine if the requested action is among permitted actions also defined by the system policy, and permits performance of the requested action if the requested action is among the permitted actions defined by the system policy.

30. A computer system according to claim 29 wherein said processor denies the requested action if the requested action is not among the permitted actions defined by the system policy.

31. A computer system according to claim 29 wherein the system policy denies actions for at least one of operating system functions, file functions, registry functions, library functions, communication functions and network functions.

32. A computer system according to claim 26 wherein the formal specification denies actions for at least one of operating system functions, file functions, registry functions, library functions, communication functions and network functions.

33. A computer system according to claim 26 wherein said processor executes the application in at least one of a Windows based environment, a Solaris based environment and a Linux based environment.

34. A computer system according to claim 26 wherein the application comprises at least one of a word processing application, a spread sheet application, an e-mail application, and a web browser application.
